(19) United States
(12) Patent Application Publication
(10) Pub. No.: US 2006/0157976 A1
(43) Pub. Date: Jul. 20, 2006

(54) Shock absorbing apparatus

(76) Inventors: John Graeme Paterson, Falkirk (GB); Terence McKenna Thomson, Isle of Man (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/295,796

(22) Filed: Dec. 7, 2005

(30) Foreign Application Priority Data
Dec. 8, 2004 (GB) 0426856.1

(51) Int. Cl. F16L 27/04

(52) U.S. Cl. 285/268; 285/261

(57) ABSTRACT

An exhaust coupling for axially connecting a first and second pipe segment comprising: a first flange provided at the first pipe segment; a second flange provided at the second pipe segment; connection means for connecting the first and second flanges such that, in a neutral state, an axial gap exists between adjacent ends of the first and second pipe segments; and biasing means for biasing the first and second pipe segments towards the neutral state.

The present invention relates to apparatus for absorbing the load between two bodies. In particular, but not exclusively, the invention relates to exhaust couplings.

Exhaust couplings are provided between two tube or pipe sections to connect the sections while allowing movement between the sections. The movement may be axial movement of the tubes towards or away from each other, rotational movement of one tube relative to the other, or pivoting of one tube relative to the other. Such movements can result from changes in engine torque, gear changes, or uneven road surfaces. Without this movement, damage to a component of the exhaust can occur.

One form of existing exhaust couplings is to use a helically wound flexible joint. However, it is known that such joints deteriorate significantly over time. Another form of existing exhaust coupling has a flange welded to each pipe section, and a nut and bolt arrangement draws the flanges towards each other. Typically, a spring is provided at each bolt. However, the ends of each section are brought into contact by the nut and bolt arrangement and may be held in this position using considerable force. Therefore, the spring provides no resilient shock absorption when a compressive load is applied. Furthermore, when a tensile pulse or cyclic load is applied, the ends of the pipe sections will be temporarily separated and then brought back into contact by the spring. This contact results in an impact load being applied to the whole exhaust. These inadequacies of the coupling can cause premature wear and failure of the coupling.

A modification of the exhaust coupling using a nut and bolt arrangement is disclosed in EP 0965015. For this apparatus, a first spring is provided between the flanges and the nut and a second spring is provided between each of the flanges. The first spring functions to urge the flanges together so that adjacent ends of the pipe sections are in contact, while the second spring provides a biasing force in the opposite direction (although the force is not sufficient to separate the two pipe sections). Also, the flanges are not welded to the pipe sections, or permanently connected in any other way, and so, as before, the coupling only provides shock absorption for tensile axial loads. The same problems with deterioration due to impacting of the ends of the sections can occur. It is stated that the second spring reduces the force by which each end of the two sections are held in contact and this allows for easier relative movement between the two segments. Otherwise, the second spring provides no shock absorption. Also, since the flanges are not fixed to the tube sections, the degree of movement of each pipe section relative to the other may be excessive under certain operating conditions.

According to a first aspect of the present invention, there is provided an exhaust coupling for axially connecting a first and second pipe segment comprising:
a first flange provided at the first pipe segment;
a second flange provided at the second pipe segment;
connection means for connecting the first and second flanges such that, in a neutral state, an axial gap exists between adjacent ends of the first and second pipe segments; and
biasing means for biasing the first and second pipe segments towards the neutral state.

The neutral state can be regarded as the position of the first pipe segment relative to the second pipe segment during an unloaded condition.

Preferably, the biasing means is adapted to bias the first and second pipe segments from both an extended and a compressed state towards the neutral state.

Preferably the biasing means also provides the connection means.

Preferably a plurality of biasing means is provided circumferentially around the first and second pipe segments. Preferably three biasing means are provided circumferentially and equidistant around the first and second pipe segments.

Preferably the biasing means comprises a first spring interposing the first and second flange. Preferably the first spring has a neutral position such that the axial gap exists between adjacent ends of the first and second pipe segments. The first spring may provide shock absorption in both a tensile and compressive loading direction.

Preferably the biasing means includes a second spring interposing the first and second flanges. Preferably the first spring and the second spring are co-axially mounted. Preferably the first spring is a tension spring having engaging means provided at each end for engaging with a retaining portion provided at each of the first and second flanges. Preferably the engaging means comprises a loop member for looping around the retaining portion. Preferably the second spring comprises a compression spring which is provided around the tension spring.

Preferably each of the first and second pipe segments has a flared portion provided at the adjacent ends of the first and second pipe segments.

Preferably the first and second flanges act upon the respective flared portion of the first and second pipe segments.

Preferably the first flange is connected to the first pipe segment.

Preferably the second flange is connected to the second pipe segment.

According to a second aspect of the present invention there is provided an apparatus for absorbing a load between a first and second body comprising:
biasing means comprising:
   a first resilient member for urging the first and second bodies towards each other; and
   a second resilient member for urging the first and second bodies apart,
wherein the first and second resilient members are co-axially mounted.

Preferably the first resilient member comprises a tension spring. Preferably the second resilient member comprises a compression spring.

Preferably the first resilient member retains the second resilient member. Preferably the second resilient member at least partially encloses the first resilient member.

Preferably the first resilient member is pre-tensioned. Preferably the second resilient member is pre-compressed.

An embodiment of the present invention will now be described, by way of example only, with reference to the accompanying drawings, in which:

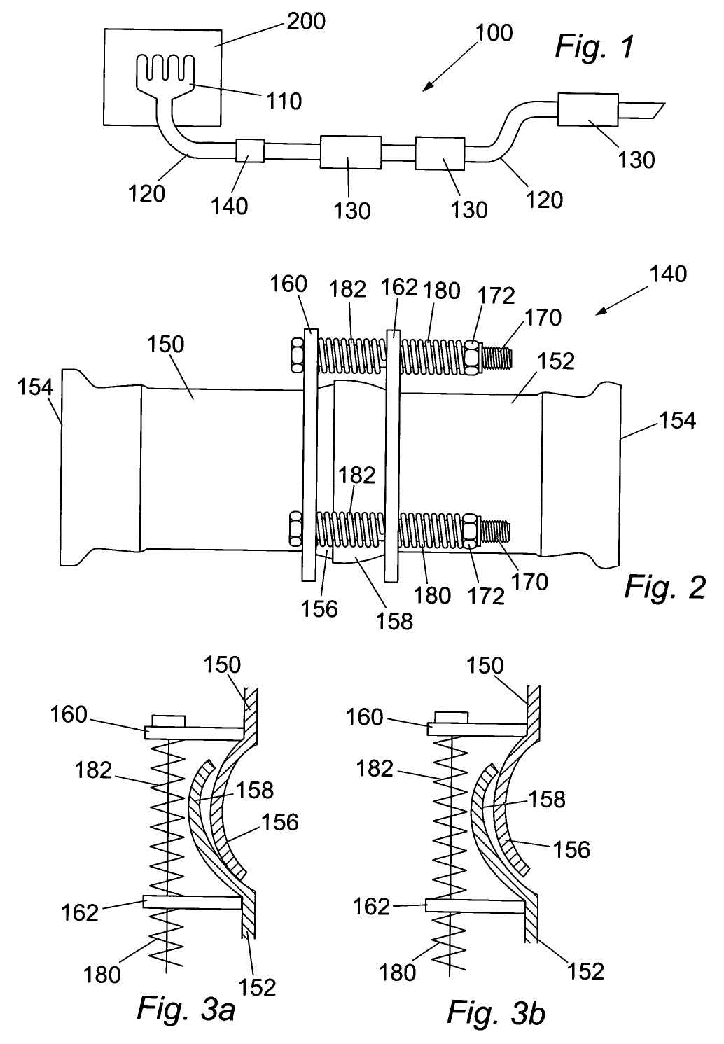

FIG. 1 is a diagrammatic view of an engine and exhaust system including an exhaust coupling according to the invention or the prior art;

FIG. 2 is a side view of an exhaust coupling according to the prior art;

FIG. 3 is a sectional side view of the exhaust coupling of FIG. 2 in (a) a first position and (b) a second position;

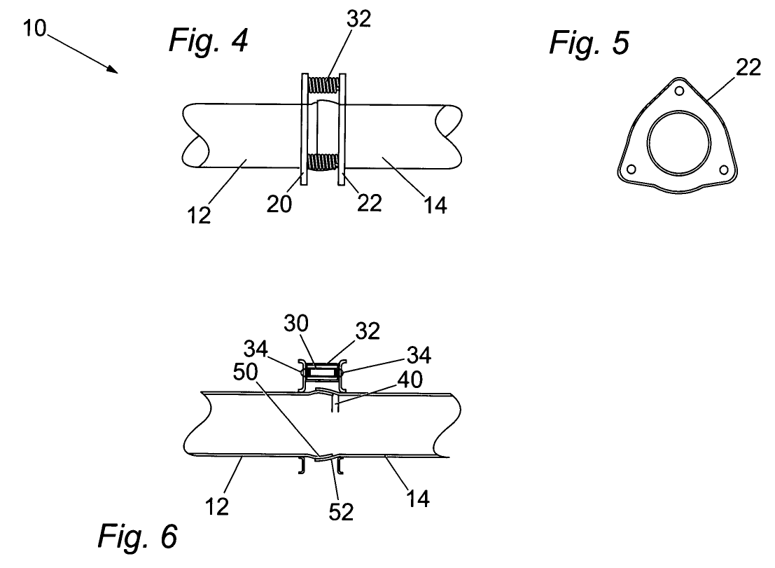

FIG. 4 is a side view of a first embodiment of an exhaust coupling according to the invention;

FIG. 5 is an end view of the exhaust coupling of FIG. 4;

FIG. 6 is a sectional side view of the exhaust coupling of FIG. 4;

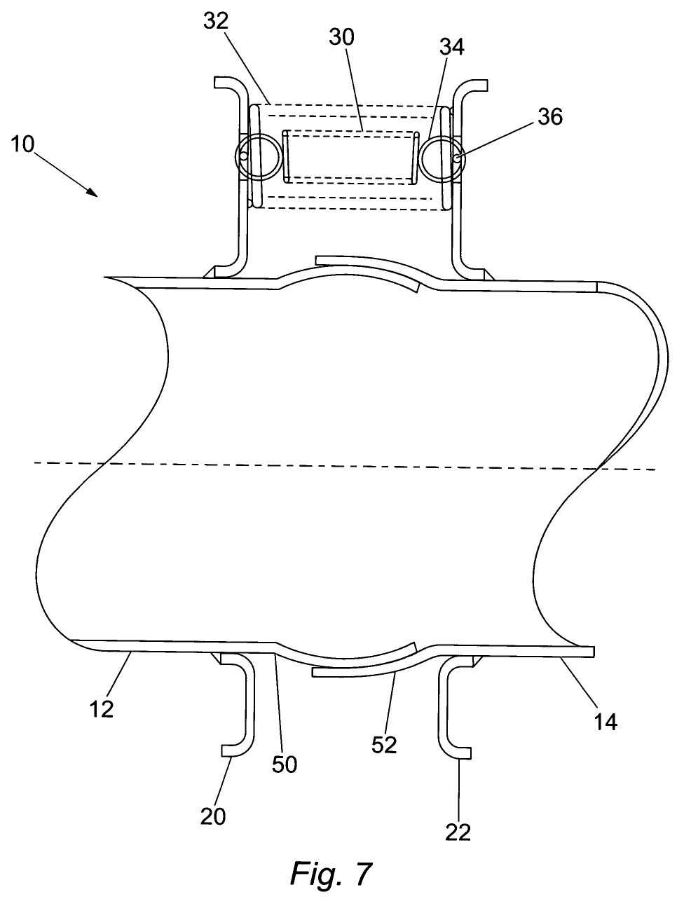

FIG. 7 is a detailed sectional view of a portion of the exhaust coupling of FIG. 4 at a first position;

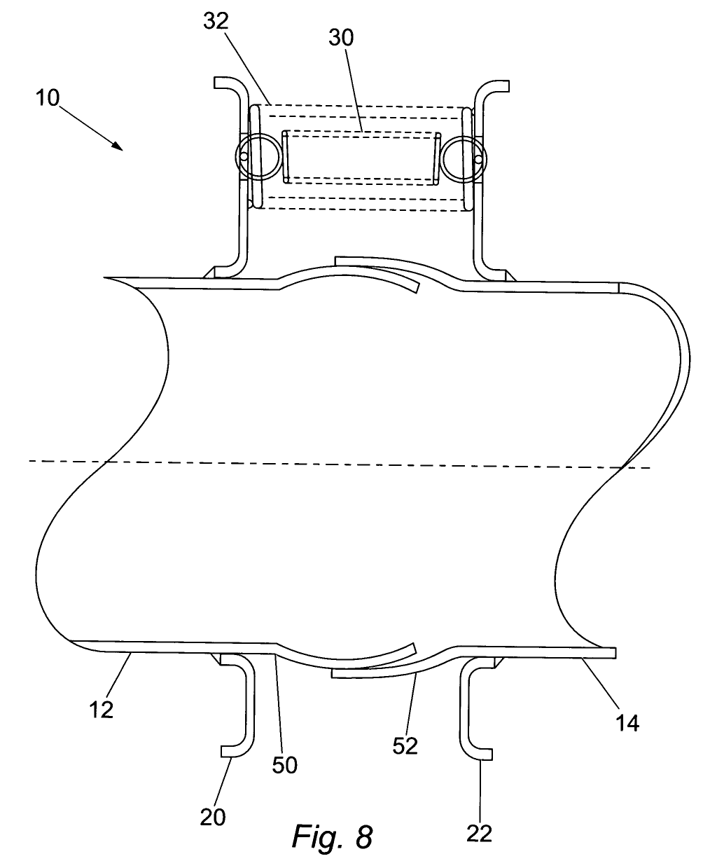

FIG. 8 is a detailed sectional view of a portion of the exhaust coupling of FIG. 4 at a second position;

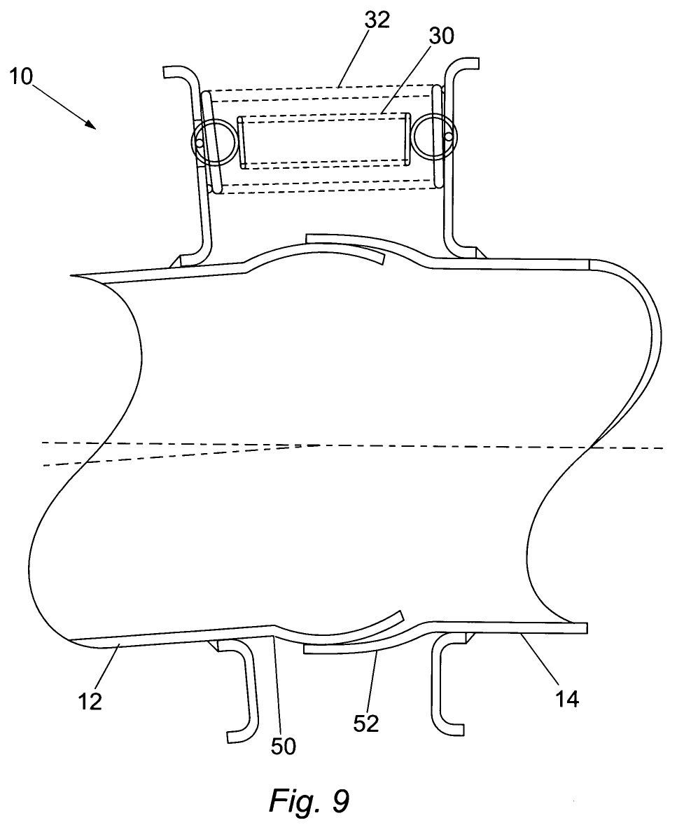

FIG. 9 is a detailed sectional view of a portion of the exhaust coupling of FIG. 4 at a third position;

FIG. 1 shows an exhaust system 100 attached to an engine 200. The exhaust system 100 includes a manifold 110 and various pipe work 120 and a number of silencer boxes 130. Positioned at one or more locations along the pipe work is an exhaust coupling 140.

A prior art coupling is shown in more detail in FIG. 2. The coupling 140 includes a first and second pipe section 150, 152 having distal ends 154 for connection to the pipe work 120. The adjacent ends 156, 158 are bevelled and slidably engage with each other, and their profile is shown in FIG. 3.

A flange 160, 162 is slidably attached to each pipe section 150, 152 and the bevelled adjacent ends 156, 158 represent a stop for the flanges 160, 162 when they are moved towards each other. The flanges 160, 162 have three circumferentially spaced apertures for receiving a bolt 170, and threaded on each bolt 170 is a nut 172.

A first compression spring 180 is provided between each nut 172 and the second flange 162. When the nut 172 is tightened, this causes the second flange 162 to be urged towards to first flange 160 thereby causing adjacent ends 156, 158 of the pipe sections 150, 152 to abut such that the coupling 140 is in the first position as shown in FIG. 3(a). A second spring 182, also a compression spring, is provided between each of the flanges 160, 162. The second spring 182 provides a biasing force in the opposite direction from the first spring 180 but the biasing force is not sufficient to separate the two pipe sections 150, 152. Rather, it is intended that the second spring 182 reduces the force by which each of the sections 150, 152 are held in contact.

When the exhaust coupling 140 receives an axial tensile load, the adjacent ends 156, 158 will move apart until the coupling 140 is at the position shown in FIG. 3(b). However, when the load is removed, the adjacent ends 156, 158 will be urged back into contact and the impact can cause damage to the adjacent ends 156, 158 or spread to any of the other components of the exhaust system 100. Also, it is clear that there is no absorption of an impact in the axial compressive direction since the normal position of the adjacent ends 156, 158 is to be abutting.

FIG. 4 shows an exhaust coupling 10 according to the present invention. The coupling 10 comprises a first flange 20 which is welded to a first pipe section 12 and a second flange 22 which is welded to a second pipe section 14. Means for connecting the first and second flanges 20, 22 are provided in the form of a first spring 30 and a second spring 32. The first and second spring 30, 32 are arranged such that, when the exhaust coupling 10 is in an unloaded or neutral state, an axial gap 40 exists between adjacent ends 50, 52 of the first and second pipe sections 12, 14.

The first spring 30 is a standard tension spring comprising a helical coil with fastening loops 34 provided at each end. A middle bar section 36 is provided at each aperture for mounting the first spring 30 using the loops 34. Around the first spring 30 is provided the second spring 32 which is a standard compression spring comprising a helical coil which offers a substantially flat loading surface at each end. Therefore, the first spring 30 and the second spring 32 are co-axially mounted. The first spring 30 also retains the second spring 32 when the coupling 10 is in an extended state.

Three of these spring arrangements are provided circumferentially and equidistant around the first and second pipe sections 12, 14.

The exhaust coupling 10 is arranged such that the first spring 30 is pre-tensioned and the second spring 32 is pre-compressed but, due to equilibrium of forces, the pipe sections 12, 14 have an unloaded or neutral state in which the axial gap 40 exists.

FIG. 7 shows the exhaust coupling 10 in a fully compressed state. In this state, the adjacent ends 50, 52 are abutting. However, the stiffness of at least the second spring 32 can be selected such that this state is only caused by a load which exceeds normal loading conditions. The stiffness of the first spring 30 may also contribute to absorption of impact load.

FIG. 8 shows the exhaust coupling 10 in an excessively extended state. If further extension was to occur, exhaust gases within the coupling 10 would be able to escape to atmosphere. However, the stiffness of at least the first spring 30 can be predetermined such that a load which causes this excessive extension is beyond the normal loading conditions. The stiffness of the second spring 32 may also contribute to absorption of impact load.

Therefore, the spring arrangement of the coupling 10 provides absorption of an impact load in both the tensile and compressive axial directions. It should also be noted that the spring arrangement of the coupling 10 provides impact absorption when the pipe sections 12, 14 and the coupling 10 experience either a torsional load or a bending load of one of the pipe sections relative to the other. This latter condition is shown in FIG. 9.

The present invention eliminates the need to provide nut and bolt arrangements which add to the cost and complexity of providing or assembling an exhaust coupling.

The dual spring arrangement of the present invention offers other advantages. Firstly, rather than the linear response of a single spring, a non-linear response can be achieved. Also, a different response in tension than in compression can be provided. Also, non-linearity and a different response in the tensile and compressive direction can be used to avoid a resonant response during vibrational loading.

It is to be appreciated that the present invention is not limited to use as an exhaust coupling. Rather, the invention provides an apparatus for absorbing the load between any two bodies when the dual spring arrangement is utilised. The spring arrangement need only comprise a first spring for urging the first and second bodies together and a second spring for urging the first and second bodies apart, wherein the first and second springs are co-axially mounted.

Nevertheless, it is to be appreciated that the present invention is not to be limited to a dual spring arrangement. It is clear that a single spring can provide tensile and compressive impact absorption provided that an axial gap exists between ends of the bodies to which the spring is provided.

Various modifications and improvements can be made without departing from the scope of the present invention.

1. An exhaust coupling for axially connecting a first and second pipe segment comprising:
a first flange provided at the first pipe segment;
a second flange provided at the second pipe segment;
connection means for connecting the first and second flanges such that, in a neutral state, an axial gap exists between adjacent ends of the first and second pipe segments; and
biasing means for biasing the first and second pipe segments towards the neutral state.

2. An exhaust coupling as claimed in claim 1, wherein the biasing means is adapted to bias the first and second pipe segments from both an extended and a compressed state towards the neutral state.

3. An exhaust coupling as claimed in claim 1, wherein the biasing means also provides the connection means.

4. An exhaust coupling as claimed in claim 1, wherein a plurality of biasing means is provided circumferentially around the first and second pipe segments.

5. An exhaust coupling as claimed in claim 4, wherein three biasing means are provided circumferentially and equidistant around the first and second pipe segments.

6. An exhaust coupling as claimed in claim 1, wherein the biasing means comprises a first spring interposing the first and second flange, and wherein the first spring has a neutral position such that the axial gap exists between adjacent ends of the first and second pipe segments.

7. An exhaust coupling as claimed in claim 6, wherein the biasing means includes a second spring interposing the first and second flanges.

8. An exhaust coupling as claimed in claim 7, wherein the first spring and the second spring are co-axially mounted.

9. An exhaust coupling as claimed in claim 7, wherein the first spring is a tension spring having engaging means provided at each end for engaging with a retaining portion provided at each of the first and second flanges.

10. An exhaust coupling as claimed in claim 7, wherein the second spring comprises a compression spring which is provided around the tension spring.

11. An exhaust coupling as claimed in claim 1, wherein each of the first and second pipe segments has a flared portion provided at the adjacent ends of the first and second pipe segments.

12. An exhaust coupling as claimed in claim 11, wherein the first and second flanges act upon the respective flared portion of the first and second pipe segments.

13. An exhaust coupling as claimed in claim 1, wherein the first flange is connected to the first pipe segment, and wherein the second flange is connected to the second pipe segment.

14. An apparatus for absorbing a load between a first and second body comprising:
biasing means comprising:
a first resilient member for urging the first and second bodies towards each other; and
a second resilient member for urging the first and second bodies apart,
wherein the first and second resilient members are co-axially mounted.

15. An apparatus as claimed in claim 14, wherein the first resilient member comprises a tension spring.

16. An apparatus as claimed in claim 14, wherein the second resilient member comprises a compression spring.

17. An apparatus as claimed in claim 14, wherein the first resilient member retains the second resilient member.

18. An apparatus as claimed in claim 14, wherein the second resilient member at least partially encloses the first resilient member.

19. An apparatus as claimed in claim 15, wherein the first resilient member is pre-tensioned.

20. An apparatus as claimed in claim 16, wherein the second resilient member is pre-compressed.
